(19) United States
(12) Patent Application Publication
(10) Pub. No.: US 2026/0246805 A1
(43) Pub. Date: Aug. 20, 2026

(54) SYSTEMS AND METHODS FOR DETERMINING SECURITY VULNERABILITIES THAT REPRESENT EDGE CASES WITHIN A DISTRIBUTED COMPUTING SYSTEM

(71) Applicant: Capital One Services, LLC, McLean, VA (US)

(72) Inventors: Lokesh VIJAY KUMAR, Frisco, TX (US); Ryan M. PARKER, The Colony, TX (US); Debora MAIA SILVA, McLean, VA (US)

(73) Assignee: Capital One Services, LLC, McLean, VA (US)

(21) Appl. No.: 19/059,248

(22) Filed: Feb. 20, 2025

(51) Int. Cl. H04L 9/40

(52) U.S. Cl. CPC H04L 63/1433

(57) ABSTRACT

Systems and methods for determining security vulnerabilities that represent edge cases within a distributed computing system are disclosed. For example, a system can be configured to obtain requirement data associated with requirement updates in response to one or more events, the one or more events involving execution of first network operations in a first network environment. The system can determine first deficiencies associated with the execution of the first network operations based on the requirement updates and the first network operations. In response to comparing the first deficiencies to the execution of second network operations in a second network environment, the system can determine second deficiencies associated with the second network environment. The system can provide an indication of the second deficiencies to cause one or more updates to be performed, the updates indicating one or more reconfigurations for the second network environment.

### BACKGROUND

Computer networks can be configured to satisfy various standards addressing, among other things, data security, privacy, and operational integrity. And as these standards change, updates can be applied to these networks to address possible deficiencies that bring the network configuration back into alignment with these standards. For example, as cybersecurity attacks increase in sophistication, network administrators can identify corresponding security vulnerabilities that can allow these attacks to be successful and reconfigure these computer networks to reduce the chances that similar attacks will later succeed.

But as these networks increase in size and complexity (e.g., as additional systems are added), it can become increasingly difficult to isolate portions of the network that need to be updated and perform these updates. For example, network administrators can manually review the configuration for each component of a network to determine whether the configuration is updated appropriately. However, it can become infeasible for network administrators to manually perform this review, particularly when addressing edge cases where indications of non-compliance occur infrequently. This, in turn, can make it more difficult to detect and address system vulnerabilities, and prolong the window during which the network is subject to potential attacks that can lead to, among other things, unnecessary resource consumption (e.g., through malicious activities such as cryptojacking, distributed denial-of-service (DDoS) attacks, unauthorized data exfiltration, etc.).

### SUMMARY

In view of these challenges, systems and methods are described herein relating to novel uses and/or improvements in the analysis of network operations to identify vulnerabilities within one or more networks. For example, techniques are described herein that relate to, among other things, the determination of deficiencies associated with the execution of network operations by a first network environment, comparison of aspects of the deficiencies to execution of network operations by a second network environment, and the determination of one or more deficiencies in the second network environment.

By identifying and comparing the known deficiencies associated with execution of network operations by a first network environment to the execution of network operations by a second network environment, vulnerabilities in the configuration of the second network environment can be more quickly identified and addressed. This, in turn, can allow for the reconfiguration of the second network environment to reduce or prevent the intentionally or inadvertently exploitation of vulnerabilities in the second network environment. And in some instances, by identifying deficiencies, such as areas of non-compliance, more quickly, the need to execute additional network operations when correcting errors present in earlier network operations can be reduced or eliminated, conserving network communication and computing resources involved in processing these network operations (e.g., within a given network environment).

In one example, firewall misconfigurations, such as incorrect initial setup, failure to update rules, overly permissive policies, and errors in rule sets, can create vulnerabilities that malicious third parties can exploit to gain unauthorized access to networks. These misconfigurations can compromise security and lead to a waste of computing resources and memory, as improperly configured firewalls can be exploited by these malicious third parties to cause devices protected by the firewalls to process unnecessary traffic or execute inefficient rule sets, consuming excessive processing cycles and memory that could be better utilized for legitimate network operations. By implementing the techniques described herein, systems can significantly and more quickly reduce or eliminate the window of opportunity for malicious third parties to exploit these vulnerabilities, allowing for the prompt addressing and rectification of deficiencies before such malicious third parties can discover and take advantage and launch data exfiltration or resource consuming attacks.

In another example, payment processing network misconfigurations can lead to vulnerabilities regarding compliance with regulatory requirements that can result in data breaches, unauthorized access, or improper processing of some types of network operations (e.g., payment transactions, etc.). In one example, with respect to handling payment disputes, a system can be misconfigured to indicate the disputed amount in the account holder's balance (which should not be indicated as the dispute is processed). This can result in the need to execute additional network operations (e.g., payment transactions, reissued statements, etc.), to correct any data discrepancies that resulted and ensure the balance is correctly reflected in a subsequently issued statement when bringing the system back into compliance with industry regulations and standards. Similar to above, by implementing the techniques described herein, systems can significantly and more quickly reduce or eliminate the window during which network operations can be processed using the misconfigured payment processing network, allowing for the reduction or elimination of the need to process additional network operations to correct these discrepancies, along with the corresponding computing and networking resources involved in processing these additional network operations.

In some aspects, systems and methods are described herein relating to determining security vulnerabilities that represent edge cases within a distributed computing system. For example, a system can obtain requirement data associated with one or more requirement updates to bring a network environment into compliance with one or more requirements in response to one or more events that compromise network environments. The one or more events can involve execution of one or more first network operations in a first network environment. In some examples, the system can determine one or more first deficiencies associated with the execution of the one or more first network operations based on the one or more requirement updates and the one or more first network operations. The one or more first deficiencies can indicate one or more security vulnerabilities of the first network environment, etc. The system can then compare one or more aspects of the one or more first deficiencies to execution of one or more second network operations in a second network environment. In some examples, in response to comparing the one or more aspects of the one or more first deficiencies to the execution of one or more second network operations in a second network environment, the system can determine one or more second deficiencies indicating the one or more security vulnerabilities associated with the second network environment. In some examples, the system can provide an indication of the one or more second deficiencies to cause one or more updates to be performed, the one or more updates indicating one or more reconfigurations for the second network environment.

While the present disclosure discusses deficiencies as they relate to security vulnerabilities, it will be understood that other deficiencies are contemplated such as, for example, deficiencies related to non-adherence to industry standards, regulatory standards, etc. In some examples, deficiencies can be related to non-adherence to industry standards and regulatory requirements and can lead to various operational disadvantages, such as quality deficiencies, interoperability problems, reduced system efficiency, and so on. Similarly, deficiencies related to regulatory non-compliance can result in operational disruptions, the need to reprocess network operations, etc.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram of a system for determining security vulnerabilities that represent edge cases within a distributed computing system, in accordance with one or more embodiments.

FIGS. 2A-2C show an illustrative flow diagram of an example implementation of a process for determining security vulnerabilities that represent edge cases within a distributed computing system, in accordance with one or more embodiments.

FIG. 3 shows illustrative components for a system used to determine security vulnerabilities that represent edge cases within a distributed computing system, in accordance with one or more embodiments.

FIG. 4 shows a flowchart of the steps involved in determining security vulnerabilities that represent edge cases within a distributed computing system, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention can be practiced without these specific details or with an equivalent arrangement. In other cases, well-known structures and devices are shown in block diagram form in order to avoid unnecessarily obscuring the embodiments of the invention.

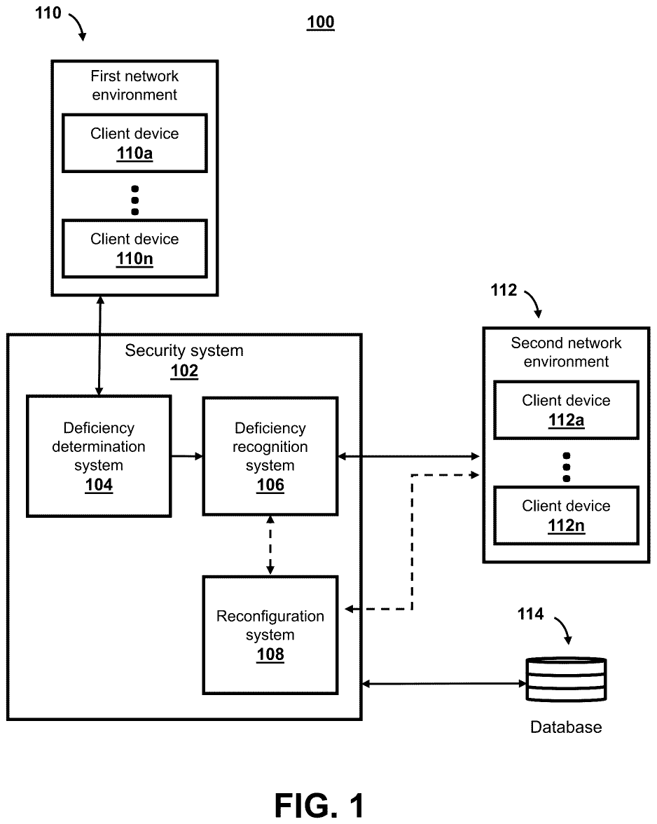

FIG. 1 shows a diagram of an environment 100 that can be configured to, among other things, determine security vulnerabilities that represent edge cases within a distributed computing system, in accordance with one or more embodiments. For example, the environment 100 can include a security system 102 having one or more components as described herein, a first network environment 110, a second network environment 112, and a database 114. The security system 102 (e.g., one or more components of the security system 102), the first network environment 110, the second network environment 112, and the database 114 can be configured to interconnect using one or more wired and/or wireless connections. As will be understood, the environment 100 includes the security system 102, the first network environment 110, the second network environment 112, and the database 114, but similar environments can include different configurations having different numbers of security systems and/or network environments that are the same as, or similar to, the security system 102, the first network environment 110, and/or the second network environment 112.

In some embodiments, the security system 102 can include a computing device that is configured to be in communication with the first network environment 110, the second network environment 112, and/or the database 114 using one or more secured or unsecured communication paths (also referred to as communication connections) as described herein. For example, the security system 102 can include a desktop computer, a laptop computer, a smartphone, a tablet, etc. In some embodiments, the security system 102 can include (e.g., implement) a deficiency determination system 104, deficiency recognition system 106, and a reconfiguration system 108. While certain components are illustrated by FIG. 1 and described as performing one or more operations, the security system 102 can include and/or exclude one or more of the illustrated components.

In some embodiments, the environment 100 can include a plurality of network environments, such as the first network environment 110 and the second network environment 112. These network environments 110, 112 can provide different allocations of resources, level of security, etc. for the devices associated with these networks and can be configured to execute network operations as described herein. For example, the network environments 110, 112 can implement a protected network with a higher level of security (e.g., a network for employees that allows more access to internal systems, a network for the communication of sensitive information such as payment information, etc.) and an unprotected network with a lower level of security (e.g., a network for customers that does not allow access to internal systems). In some examples, the first network environment 110 and the second network environment 112 can share similarities in their configuration (e.g., in their firewall configurations, the operations performed by the devices associated with the networks to complete network operations, etc.). As described herein, the safety system 102 can implement a deficiency recognition system 106 to determine deficiencies in the second network environment 112 based on the identification of deficiencies in the first network environment 110.

The first network environment 110 and the second network environment 112 can include, or be formed by, one or more client devices configured to be in communication with other client devices of each respective network environment and can coordinate execution of one or more network operations therein. For example, the first network environment 110 can include client devices 110a-110n, and the second network environment 112 can include client devices 112a-112n. In some embodiments, each client device 110a-110n, 112a-112n can include a computing device that is configured to communicate with one or more other devices illustrated in the environment 100 of FIG. 1. For example, the client devices 110a-110n, 112a-112n can include desktop computers, laptop computers, smartphones, tablets, point-of-sale devices, etc., and can be associated with users, such as employees, customers, etc. While illustrated as being independent devices, it will be understood that the one or more of the client devices 110a-110n of the first network environment 110 and one or more client devices 112a-112n of the second network environment 112 can be configured to communicate with one another and/or can be the same client device. Additionally, or alternatively, the first network environment 110 and the second network environment 112 can be implemented by a single computing device or as separate systems within a distributed computing system.

The database 114 can include one or more storage devices such as hard disk drives, solid-state drives, etc., that are configured to store and maintain data associated with network requirements usable to configure and/or reconfigure the first network environment 110 and/or the second network environment 112. As described herein, the data associated with the network requirements can indicate one or more aspects of a network configuration, such as aspects of a configuration of the first network environment 110 and/or the second network environment 112, that can be correlated with other network environments to mitigate possible security vulnerabilities, etc. As an example, the network requirements can represent standards, specifications, etc. (e.g., for the processing of financial data, health data, etc.) corresponding to aspects of the configuration of the first network environment 110 and or the second network environment 112 that indicate how data is to be handled when completing network operations, and can be updated (e.g., by organizations or agencies such as the Cybersecurity and Infrastructure Security Agency (CISA), the Consumer Financial Protection Bureau (CFPB), the Department of Health and Human Services, etc.). In some embodiments, these network requirements can be used to reconfigure one or more of the first network environment 110 and/or the second network environment 112 to address one or more deficiencies as described herein.

With continued reference to FIG. 1, in some embodiments, the database 114 can include (e.g., store and/or maintain) data associated with events including incident reports, etc., that represent improper function of a network environment such as the first network environment 110. For example, the deficiency determination system 104 can obtain incident reports associated with the first network environment 110 and/or requirement updates developed based on the identification of deficiencies in the operation of the first network environment 110 (e.g., represented by the incident reports). In one example, these incident reports can be provided by devices controlled by organizations or agencies described herein that are monitoring the operation of the network environment 110 and/or the second network environment 112 to detect and address deficiencies in the operation of the network environments.

In some embodiments, the deficiency determination system 104 can include one or more devices configured to be in communication with the first network environment 110. In this example, the deficiency determination system 104 can identify deficiencies within the first network environment 110 based on the network operations executed by the first network environment 110. In some embodiments, the deficiency determination system 104 can make this determination in response to the security system 102 determining that the requirement updated has been added to the database 114. In some embodiments, the deficiencies can be determined using a model. For example, the security system 102 can provide the requirement update and/or network operations associated with the first network environment 110 to a model (e.g., large language model (LLM) such as the Llama model, etc.) along with a prompt to cause the model to identify relationships and correlations to, among other things, creating a linked knowledge graph. The security system 102 can then cause the model to generate one or more indications of deficiencies (e.g., a summary of deficiencies, phrases that can indicate deficiencies, etc.). In this example, the deficiency determination system 104 can then correlate the determined deficiencies of the first network environment 110 in a configuration of a different network environment, such as the second network environment 112. As described herein, the deficiency determination system 104 can also be configured to be in communication with deficiency recognition system 106.

In another example, these incident reports can be obtained by a retrieval-augmented generation model (RAG model) associated with the security system 102 and/or deficiency determination system 104 from one or more devices (not explicitly illustrated) associated with different data sources (e.g., public news outlets, court reporters, etc.). For example, the RAG model can be trained and/or capable of accessing data across various information sources (e.g., the organizations or agencies described, courts, news agencies, etc.) and can be prompted to identify deficiencies in the first network environment 110 based on publications (e.g., organization or agency announcements, court documents, etc.) that are generated in response to the execution of operations within the first network environment 110. In this example, the incident reports can be used to generate suggestions and/or requirement updates that are usable to address deficiencies in similar network environments (such as the second network environment 112) and reduce or eliminate the chances of future occurrences of similar errors. In some examples, information included in the database 114 can be based on information collected from a plurality of sources, such as external regulatory databases, internal event logs, etc. Once determined, the requirement update can be added to the database 114 and associated with the deficiency identified as a result of execution of operations by the first network environment 110 as identified by a device externally auditing the execution of network operations by the first network environment 110.

In some embodiments, the security system 102 can determine that one or more requirement updates have been included (e.g., represented) in the database 214 while monitoring operation of the first network environment 110 and/or the second network environment 112. For example, the security system 102 can determine that a requirement update has been added to the database 114, and then determine one or more first deficiencies within the first network environment 110 that are based on the requirement update. The security system 102 can then implement the deficiency recognition system 106 to identify similar second deficiencies within the second network environment 112 by correlating the deficiencies of the first network environment 110 with the second network environment 112.

In some embodiments, the deficiency recognition system 106 can include one or more devices, modules, etc. that can be configured to be in communication with the deficiency determination system 104 and/or the second network environment 112. For example, the deficiency recognition system 106 can be configured to determine second deficiencies associated with the second network environment 112 based on the first deficiencies associated with the first network environment 110.

In some embodiments, the deficiency recognition system 106 can receive an indication of the one or more first deficiencies associated with the first network environment 110 from the deficiency determination system 104. The deficiency recognition system 106 can then compare the first deficiencies to the second network operations and/or the configuration of the second network environment 112 to identify one or more second deficiencies of the second network environment 112 related to a given requirement update. In some embodiments, the deficiency recognition system 106 can retrieve data from the database 114. For example, the deficiency recognition system 106 can retrieve data associated with the requirement update and/or one or more first deficiencies from the database 114 and determine the one or more second deficiencies based on the one or more first deficiencies. In some embodiments, the deficiency recognition system 106 can then provide an indication of the one or more second deficiencies to the reconfiguration system 108 to cause the reconfiguration system 108 to execute one or more operations as described herein. As a result of determining the second deficiencies based on the first deficiencies, the security system 102 can efficiently and accurately identify deficiencies that could result in security vulnerabilities across similar network environments, despite such deficiencies not necessarily having affected the execution of network operations executed by the second network environment 112.

The reconfiguration system 108 (which can also be referred to as a compliance rules engine) can include one or more devices, modules, etc. that can be configured to be in communication with the deficiency recognition system 106 and/or the second network environment 112. In some embodiments, the reconfiguration system 108 can generate and/or perform one or more updates to the second network environment 112 (e.g., to the configuration of the second network environment) based on the second deficiencies associated with the second network environment 115. For example, the second network environment 112 can perform or cause updates to be implemented (e.g., patches, reconfigurations, etc.) by the client devices 110a-110n, 112a-112n of the first network environment 110 and/or second network environment 112. These updates can include updates to the configurations of the respective client devices in the first network environment 110 and/or the second network environment 112, isolation of segments of the network (e.g., using firewalls VLANs, etc.), the enablement of encryption, or change of authentication protocols (e.g., enacting password requirements, implementing multi-factor authentication, etc.), and/or the like. In some embodiments, the reconfiguration system 108 can determine that one or more updates would address the second deficiencies and then implement these updates. In some implementations, the second network environment 112 can be configured by the reconfiguration system 108 to be in compliance with the requirement update as a result of these updates.

In another example, these updates indicated and/or performed by the reconfiguration system 108 can include updates to the way in which client device(s) within either the first network environment 110 or second network environment execute network operations. For example, these updates can include changes to the way in which network operations representing payment transactions are processed using various client devices of the respective network environments. In one example, where the first network environment 110 is associated with deficiencies in the calculation of interest based on dispute amounts (e.g., where the dispute amount is reintroduced into the interest calculation from pay period to pay period), an update can be generated and performed by the reconfiguration system 108 to the second network environment 112 to cause the second network environment to calculate interest payments without including the dispute amount similar to as was calculated by the first network environment 110 before the deficiency was identified. In this way, as the updates are identified they can be correlated with aspects of the second network environment 212 to reduce or eliminate the chances that they will affect operations performed by the second network environment 112.

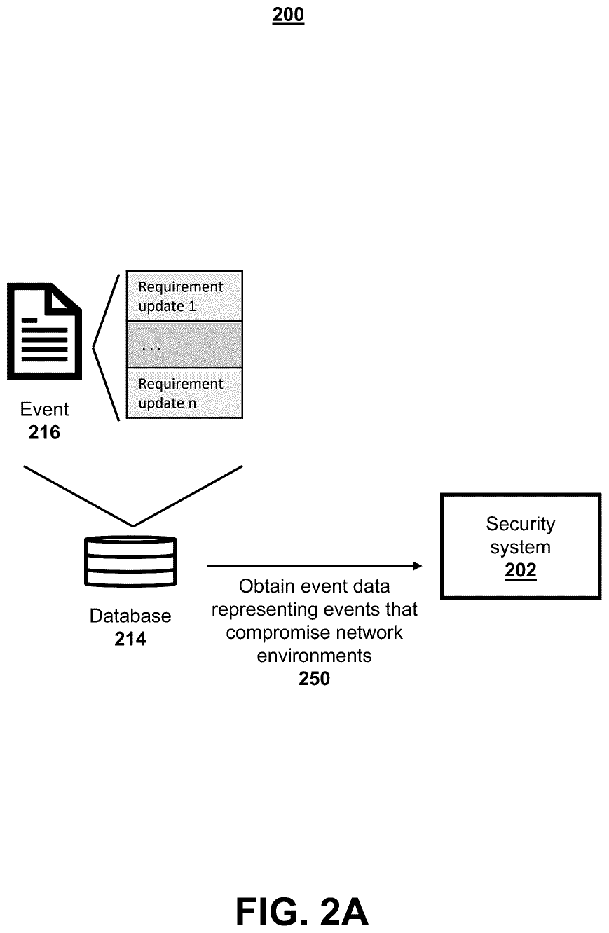

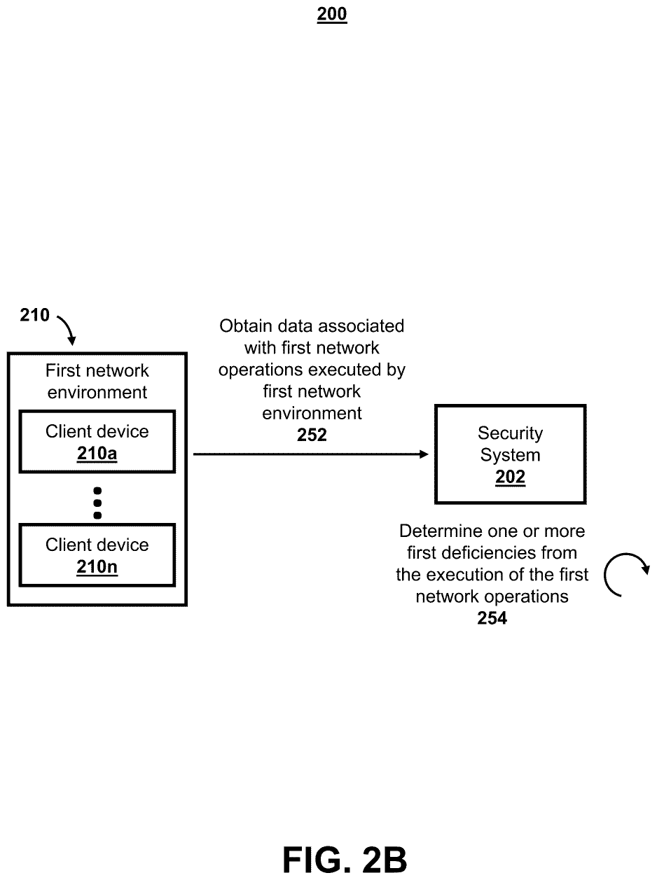

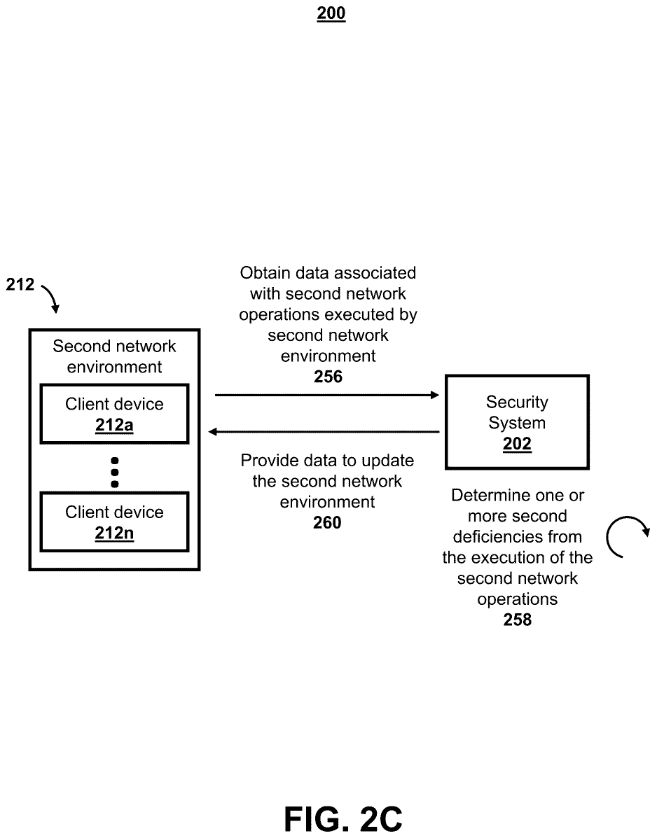

FIGS. 2A-2C show a flow diagram of an example implementation of a process 200 for determining security vulnerabilities that represent edge cases within a distributed computing system, in accordance with one or more embodiments. As illustrated, certain operations can be performed by a security system 202. In some embodiments, the security system 202 can be the same as, or similar to, the security system 102 of FIG. 1. It will be understood that one or more different devices referenced herein (e.g., that are the same as, or similar to, those illustrated in FIG. 1) can be used to perform some or all of the operation described as being performed by the security system 202.

In some embodiments, a database (e.g., that is the same as, or similar to, the database 114 of FIG. 1) can be updated to include data associated with an event. The event can represent one or more aspects of one or more first network operations executed by a first network environment. The event can also be associated with one or more requirement updates that were determined based on the identification of deficiencies during the execution of the network operations. As a result, the database can be updated as events occur and are analyzed to maintain an index of requirement updates that can be used to configure or reconfigure network environments.

In some embodiments, the event can be analyzed (e.g., by a device managed by a third-party such as an agency, etc., as described herein) to identify the one or more requirements updates to be performed to network environments. For example, the event can be associated with a new standard set by an organization (e.g., a new standard for handling credit card information set by the Payment Card Industry Security Standards Council (PCI SSC), etc.) and can represent one or more changes to one or more configurations of a network environment to address the deficiencies associated with the event. As another example, the event can include an incident report associated with one or more deficiencies related to the execution of the network operations by a network environment. For example, the event 216 can include an incident report that indicates one or more network operations were executed in accordance with the deficiency of a network environment such as the first network environment 210, indicating aspects of the network environment that are attributed to the deficiencies and to be updated.

In some embodiments, the requirement updates can indicate aspects of network environments that can be reconfigured to resolve similar deficiencies as those represented by the event. For example, the requirement update can indicate one or more aspects of a configuration of a first network environment 210 to be changed that can reduce or eliminate the chances of similar deficiencies being represented by the execution of network operations and similar network environments such as the second network environment 212. In some examples, these reconfigurations can be to address identified security vulnerabilities or other deficiencies as described herein. In some of the examples described, the requirement update can be represented using one or more text files, one or more predetermined file formats, etc.

In one example, the event can be associated with a requirement update that addresses a misconfiguration of a network environment resulting in deficiencies such as unauthorized access to data, improper credits to an account, or incorrect configurations of account settings. In another example, the event can be associated with a requirement update responsive to an incident where an account was incorrectly charged interest on a monthly statement during analysis of a disputed network operation (e.g., a disputed payment transaction). In this example, the requirement update can indicate that interest calculations should only be calculated for confirmed transactions. This could be an example of an edge case, as disputed network operations may typically be settled within a few days, making it rare for a disputed network operation to affect the balance used to calculate the interest across multiple pay periods. When a disputed network operation does affect the interest calculation (e.g., by being incorrectly included in the calculation), the requirement update can indicate that the network environment involved (e.g., a first network environment 210 as described herein) was configured incorrectly and that similar network environments (e.g., a second network environment 212) should be reconfigured to avoid this deficiency.

At operation 250, the security system 202 can obtain the event data representing the events and/or corresponding requirement data when monitoring one or more network environments. For example, the security system 202 can obtain the event data representing the events, where the events are correlated with interactions between client devices 210a-210n that occur within the first network environment 210. This event data can be represented as raw data obtained from sources such as, for example, organizations that issue regulatory updates, enforcement actions, internal events, etc. This event data can be maintained in association with regulatory databases, internal databases, event logs, and can be periodically or continuously obtained (e.g., “pulled”) from these sources. In some examples, these events can include the execution of network operations by the first network environment 210 that can indicate deficiencies in the configuration of the first network environment 210. As an example, these events can be represented by data associated with a first set of network operations that are executed by the network environment 210 that are identified and stored in the database.

In some embodiments, the security system 202 can periodically or continuously monitor the database for new entries, such as updates to the event, which describe deficiencies in network environments as they are identified. In response to determining that an event includes a new entry in the database, the security system 202 can obtain (e.g., download) the new entry from the database. In some examples, the security system 202 can monitor the database for specific types of entries, such as those related to a certain type of network environments or certain types of network operations. This can, for instance, include entries associated with a certain network type of a network environment that is associated with the security system 202 (e.g., a network type associated with a first network environment 210 discussed below).

At operation 252, the security system 202 can obtain data associated with first network operations executed by a first network environment 210. For example, the security system 202 can obtain the data associated with first network operations based on (e.g., in response to) execution of a plurality of first network operations that involve client devices 210a-210n of the first network environment 210. The network operations can include activities that involve the client devices 210a-210n, such as transmission of data, execution of payment transaction between individuals controlling the client devices 210a-210n used by the first network environment 210, etc. In an example, obtaining data associated with first network operations can include obtaining files generated during execution of the network operations, such as network logs. In an embodiment, a component of the security system 202, such as a deficiency determination system (not explicitly illustrated by FIGS. 2A-2C), can obtain this data in response to the security system 202 obtaining event data associated with the event being added to the database.

At operation 254, the security system 202 can determine one or more first deficiencies in the first network environment 210 from the execution of the first network operations by the first network environment 210. For example, the deficiency determination system implemented by the security system 202 can determine the first deficiencies based on analyzing the event data and the first network operations data and correlating the deficiencies with aspects of the network operations executed by the first network environment 210 and/or the configuration of the first network environment 210.

In some embodiments, the security system 202 can implement a large language model to generate a semantic output identifying one or more deficiencies associated with an event. For example, the security system 202 can use a first model (such as a RAG model) to obtain event data and/or first network operation data, then process this data to produce an output including information relevant to the event. In some embodiments, the security system 202 can use the first model to gather additional information from the network environments it oversees (e.g., the network environment 210 and/or the network environment 212), and provide this information to a second model to generate context (for instance, an incident report) for the event. In some cases, the system can use the resulting semantic output to detect first deficiencies and/or second deficiencies in the first network environment or the second network environment.

As an example, the event at issue might be an incident report describing an improper charge of interest to an account because the interest was calculated against a disputed deposit in the first network environment. In this scenario, the security system 202 can provide data related to the event to the first model so it can retrieve relevant information from sources such as news articles or court documents. The security system 202 can then send the data obtained by the first model to the second model, along with a prompt that prompts the second model to generate the semantic output. This semantic output can include structured information indicating deficiencies within the first network environment 210. For instance, the first model might gather context about applicable industry standards regarding interest calculation, along with similar reported incidents of miscalculation by the first network environment 210. Meanwhile, the second model can summarize that data to highlight how the interest was miscalculated relative to the requirements. A deficiency determination system implemented by the security system 202 can use this semantic output to identify specific deficiencies in the first network environment 110, such as improperly including a disputed transaction in the balance used for interest calculations. In some examples, the security system 202 may base this determination on network operations data, for instance, network logs or other data representing the network operations executed by the first network environment 210.

At operation 256, the security system 202 can obtain data associated with second network operations executed by the second network environment 212. For example, a component of the security system 202, such as a deficiency recognition system, can gather network operation data capturing how multiple client devices (e.g., client devices 212a-212n) operate within the second network environment 212. In some examples, the second network environment 212 can share characteristics with the first network environment 210, such as handling similar data types or performing similar operations. Accordingly, the second network environment 212 can exhibit deficiencies similar to those of the first network environment 210.

At operation 258, the security system 202 can determine one or more second deficiencies from the execution of the second network operations. For example, the deficiency determination system can compare the first deficiencies to the second network operations and/or the configuration of the second network environment 212 and identify the second deficiencies based on similarities between them. In some examples, the deficiency determination system can obtain a representation of the second network environment 212 that includes a knowledge graph generated from the first network environment 210. In these examples, the deficiency determination system can compare the semantic output to the knowledge graph to identify instances where the semantic output matches a portion of the knowledge graph. For instance, a match within the knowledge graph may reveal one or more network misconfigurations associated with (e.g., indicated by) the requirement data.

At step 260, the security system 202 can provide data to update the second network environment 212. For example, a component of the security system 202, such as the reconfiguration system, can provide an indication of the second deficiencies to the second network environment 212 so that updates resolving these deficiencies can be carried out. In some embodiments, these indications can be sent to specific client devices within the second network environment 212. For example, the reconfiguration system can determine a hierarchy of the second deficiencies based on dependencies among client devices, then distribute the indications of the second deficiencies according to that hierarchy. This may include identifying users relevant to the second deficiencies based on an associated client device being affected, such as by examining roles and responsibilities of the users within the organization.

In reference to the above-described example wherein deficiency involves miscalculation of interest, the security system 202 can identify client devices in the second network environment 212 to provide the indication of the second deficiencies to based on identifying a first user that is responsible for interest calculation systems and a second user who has authority over the first user. As another example, the security system 202 can identify a first user that is responsible for interest calculation systems and a second user that is responsible for a downstream or upstream system that can cause or be affected by the deficiency. For example, the system can identify the second user as responsible for a minimum balance system that charges a fee if an account dips below a minimum balance. This system can be affected by miscalculations of interest, since miscalculations can result in balances being inaccurate. In some embodiments, the indication provided to the client devices associated with the first and second user may require input from these users. For example, the indication can instruct the users to modify one or more network settings. As another example, the indication can be a suggested network update that the user can approve or reject. Alternatively, the network may automatically be updated based on the indication.

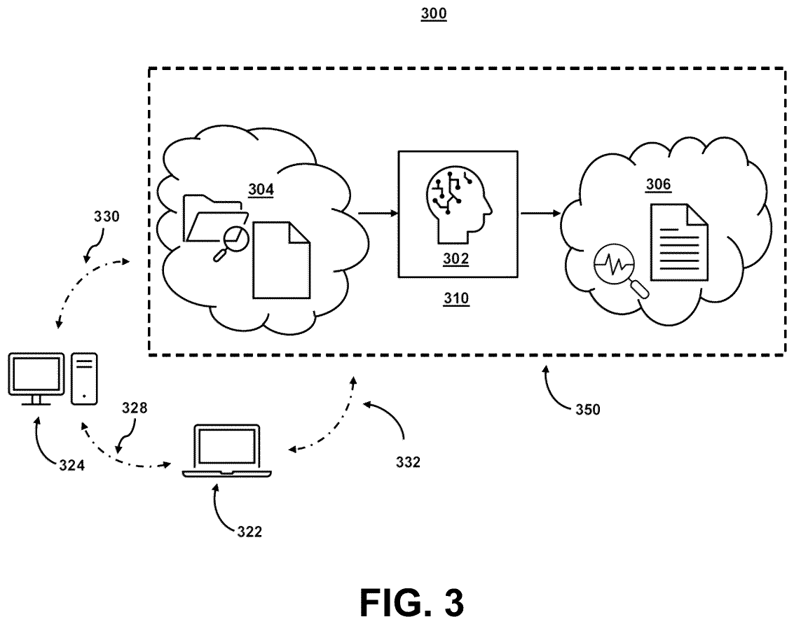

FIG. 3 shows illustrative components for a system used to determine security vulnerabilities that represent edge cases within a distributed computing system, in accordance with one or more embodiments. As shown in FIG. 3, system 300 can include mobile device 322 and user terminal 324. While shown as a smartphone and personal computer, respectively, in FIG. 3, it should be noted that mobile device 322 and user terminal 324 can be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 can alternatively be any computing device as described above, and can include any type of mobile terminal, fixed terminal, or other device. For example, cloud components 310 can be implemented as a cloud computing system and can feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein can include one or more computing devices that are programmed to perform the described functions. Additionally, or alternatively, multiple users can interact with system 300 and/or one or more components of system 300. For example, in one embodiment, a first user and a second user can interact with system 300 using two different components.

With respect to the components of mobile device 322, user terminal 324, and cloud components 310, each of these devices can receive content and data via input/output (hereinafter “I/O”) paths. Each of these devices can also include processors and/or control circuitry to send and receive commands, requests, and other suitable data using the I/O paths. The control circuitry can comprise any suitable processing, storage, and/or input/output circuitry. Each of these devices can also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices can have neither user input interfaces nor displays, and can instead receive and display content using another device (e.g., a dedicated display device such as a computer screen, and/or a dedicated input device such as a remote control, mouse, voice input, etc.). Additionally, the devices in system 300 can run an application (or another suitable program). The application can cause the processors and/or control circuitry to perform operations related to generating dynamic conversational replies, queries, and/or notifications.

Each of these devices can also include electronic storages. The electronic storages can include non-transitory storage media that electronically stores information. The electronic storage media of the electronic storages can include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages can include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages can include one or more virtual storage resources (e.g., cloud storage, a virtual private network, and/or other virtual storage resources). The electronic storages can store software algorithms, information determined by the processors, information obtained from servers, information obtained from client devices, or other information that enables the functionality as described herein.

FIG. 3 also includes communication paths 328, 330, and 332. Communication paths 328, 330, and 332 can include the Internet, a mobile phone network, a mobile voice or data network (e.g., a 5G or LTE network), a cable network, a public switched telephone network, or other types of communications networks or combinations of communications networks. Communication paths 328, 330, and 332 can separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices can include additional communication paths linking a plurality of hardware, software, and/or firmware components operating together. For example, the computing devices can be implemented by a cloud of computing platforms operating together as the computing devices.

Cloud components 310 can include one or more components of the security system 102, as mentioned above, such as a deficiency determination system, deficiency recognition system, reconfiguration system, or other components. For example, one or more cloud components 310 (e.g., one or more instances of one or more cloud components 310) can be used to implement deficiency determination system 104, deficiency recognition system 106, and reconfiguration system 108 of FIG. 1.

Cloud components 310 can access a first network environment, second network environment, and/or database. For example, cloud components 310 can access a database to determine the occurrence of an event indicating one or more requirement updates. The cloud components can then access a first network environment to determine first deficiencies. As an example, the model 302 can determine one or more first deficiencies based on the event and first network operations associated with the first network environment. In an aspect, the cloud components 310 can access one or more databases to determine context, such as relevant incident reports, related to the event. In an embodiment, the cloud components 310 can access a second network environment. For example, cloud components 310 can access second operations associated with the second network environment to determine one or more second deficiencies. Additionally, or alternatively, the cloud components 310 can access the second network environment to reconfigure one or more network configurations based on the second deficiencies.

Cloud components 310 can include model 302, which can be a machine learning model, artificial intelligence model, etc. (which can be referred collectively as “models” herein). Model 302 can take inputs 304 and provide outputs 306. The inputs can include multiple datasets, such as a training dataset and a test dataset. Each of the plurality of datasets (e.g., inputs 304) can include data subsets related to user data, predicted forecasts and/or errors, and/or actual forecasts and/or errors. In some embodiments, outputs 306 can be fed back to model 302 as input to train model 302 (e.g., alone or in conjunction with user indications of the accuracy of outputs 306, labels associated with the inputs, or with other reference feedback information). For example, the system can receive a first labeled feature input, wherein the first labeled feature input is labeled with a known prediction for the first labeled feature input. The system can then train the first machine learning model to classify the first labeled feature input with the known prediction (e.g., relevant context associated with the event and/or semantic output that can be used to determine deficiencies, such as the first or second deficiencies).

In a variety of embodiments, model 302 can update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights can be adjusted to reconcile differences between the neural network's prediction and reference feedback. In a further use case, one or more neurons (or nodes) of the neural network can require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 can be trained to generate better predictions.

In some embodiments, model 302 can include an artificial neural network. In such embodiments, model 302 can include an input layer and one or more hidden layers. Each neural unit of model 302 can be connected with many other neural units of model 302. Such connections can be enforcing or inhibitory in their effect on the activation state of connected neural units. In some embodiments, each individual neural unit can have a summation function that combines the values of all of its inputs. In some embodiments, each connection (or the neural unit itself) can have a threshold function such that the signal must surpass it before it propagates to other neural units. Model 302 can be self-learning and trained, rather than explicitly programmed, and can perform significantly better in certain areas of problem solving, as compared to traditional computer programs. During training, an output layer of model 302 can correspond to a classification of model 302, and an input known to correspond to that classification can be input into an input layer of model 302 during training. During testing, an input without a known classification can be input into the input layer, and a determined classification can be output.

In some embodiments, model 302 can include multiple layers (e.g., where a signal path traverses from front layers to back layers). In some embodiments, back propagation techniques can be utilized by model 302 where forward stimulation is used to reset weights on the “front” neural units. In some embodiments, stimulation and inhibition for model 302 can be more free-flowing, with connections interacting in a more chaotic and complex fashion. During testing, an output layer of model 302 can indicate whether or not a given input corresponds to a classification of model 302 (e.g., relevant semantic output).

In some embodiments, the model (e.g., model 302) can automatically perform actions based on outputs 306. In some embodiments, the model (e.g., model 302) can not perform any actions. The output of the model (e.g., model 302) can be used to identify deficiencies in network environments, such as the first network environment 110 or the second network environment 112 of FIG. 1).

System 300 also includes API layer 350. API layer 350 can allow the system to generate summaries across different devices. In some embodiments, API layer 350 can be implemented on mobile device 322 or user terminal 324. Alternatively, or additionally, API layer 350 can reside on one or more of cloud components 310. API layer 350 (which can be A REST or Web services API layer) can provide a decoupled interface to data and/or functionality of one or more applications. API layer 350 can provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 can use various architectural arrangements. For example, system 300 can be partially based on API layer 350, such that there is strong adoption of SOAP and RESTful Web-services, using resources like Service Repository and Developer Portal, but with low governance, standardization, and separation of concerns. Alternatively, system 300 can be fully based on API layer 350, such that separation of concerns between layers like API layer 350, services, and applications are in place.

In some embodiments, the system architecture can use a microservice approach. Such systems can use two types of layers: Front-End Layer and Back-End Layer where microservices reside. In this kind of architecture, the role of the API layer 350 can provide integration between Front-End and Back-End. In such cases, API layer 350 can use RESTful APIs (exposition to front-end or even communication between microservices). API layer 350 can use AMQP (e.g., Kafka, RabbitMQ, etc.). API layer 350 can use incipient usage of new communications protocols such as gRPC, Thrift, etc.

In some embodiments, the system architecture can use an open API approach. In such cases, API layer 350 can use commercial or open-source API Platforms and their modules. API layer 350 can use a developer portal. API layer 350 can use strong security constraints applying WAF and DDoS protection, and API layer 350 can use RESTful APIs as standard for external integration.

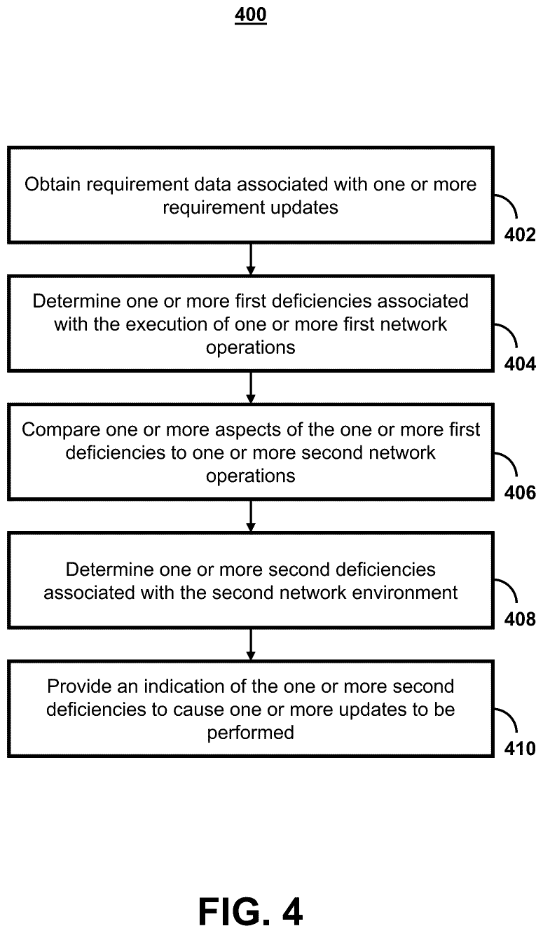

FIG. 4 shows a flowchart of the steps involved in a process 400 for determining security vulnerabilities that represent edge cases within a distributed computing system, in accordance with one or more embodiments. As described, certain operations can be performed by a security system that is the same as, or similar to, the security system 102 of FIG. 1 and/or the security system 202 of FIGS. 2A-2C. It will be understood that one or more different devices (e.g., that are the same as, or similar to, those illustrated in FIGS. 1 and 2) can be used to perform some or all of the operation described herein.

At operation 402, process 400 can include obtaining requirement data associated with one or more requirement updates. For example, a security system as described herein can obtain the requirement data in response to an event being added to a database (e.g., that is the same as, or similar to, the database 114 of FIG. 1, sometimes referred to as an external database). In some examples, the event can be used to determine and/or otherwise be associated with the requirement updates for a network environment. These requirement updates can include security updates regarding how client devices can be configured to operate within a network environment (e.g., a first network environment or a second network environment), compliance updates regarding how network operations can be processed by the client devices, etc. Additionally, or alternatively, the event can include reports of security events. For example, the security events event can include cybersecurity events where network operations were executed by malicious third parties when attacking a network environment (e.g., the first network environment). In examples where the event includes a security event, the corresponding requirement update can include one or more changes to a configuration of a network environment that can be implemented to reduce or eliminate deficiencies in that network environment that can allow for the security event to affect the network environment.

In some embodiments, the aspects of the events can indicate deficiencies that can be identified in network environments These deficiencies can be determined based on an analysis of the configuration of a network environment, a protocol according to which network operations are executed by devices in that network environment, etc. In some examples, deficiencies can be correlated with configurations of network environments that allow for atypical network traffic patterns, login attempts from locations outside of the network environment, processing of suspicious DNS requests, unauthorized changes to system configurations or registry files, etc. In another example, deficiencies can represent non-compliance with one or more regulatory requirements. For example, an event can indicate deficiencies involving network environment configurations that allow for the incorrect execution of network operations. In this example, where a network operation is associated with the completion of a payment transaction such as issuance of a statement, a deficiency can be associated with network environments that are configured to calculate interest for balances that incorrectly include disputed amounts that should not be included in such calculation, etc.

In some embodiments, the security system can monitor the database to identify the occurrence of the event. For example, the security system can monitor the database for events that are relevant to one or more network environments associated with (e.g., monitored by) the security system. In one example, the security system can monitor the database for events that are related to a specific type of data handled in by the network environment (e.g., educational data, transaction data, personal health data, etc.). As another example, the security system can monitor the database for events that are related to a specific type of network operation performed in a network environment (e.g., completion of transactions such as payments transactions, direct deposits, etc.). As yet another example, the security system can monitor the database for events that are related to a network type of a network environment monitored by the security system (e.g., payment processing network, lending network, telecommunications network, medical claims network, etc.).

In response to identifying a new entry (e.g., event) in the database that is relevant to a given network environment (e.g., to an industry, network operations, and/or network type of the associated network environment), the security system can obtain requirement data from the database. The requirement data can include indications of new requirement updates usable to reconfigure relevant network environments (e.g., a second network environment as described herein) and/or relevant incident reports associated with the event. For example, where new vulnerabilities in configurations of network environments are identified as allowing for certain types of security events to take place, requirement data can be included in the database associated with requirement updates that, when implemented, reduce or eliminate the chances that the security events will be able to affect reconfigured network environments. Similarly, where vulnerabilities are identified in how network operations are configured to be processed using a network environment, requirement data can be included in the database that indicate one or more changes to be implemented to address deficiencies in established processes for processing these network operations. This can include, for example, reconfiguring client devices in a network environment to forgo calculating interest based on disputed amounts across multiple periods until the dispute is settled, etc.

At operation 404, the process 400 can include determining one or more first deficiencies associated with the execution of one or more first network operations. For example, a component of the security system, such as a deficiency determination system, can determine first deficiencies of a first network environment monitored by the security system. These first deficiencies can include configurations of client devices and/or the first network environment itself that result in outdated or unaddressed security measures, outdated software, misconfiguration of network operation execution within the network environment, etc. In some examples, the first deficiencies can be associated with (e.g., correlated with) one or more events and corresponding requirement updates maintained by the database as described above.

In one example, a deficiency can be associated with a network environment that is misconfigured to provide access to a resource to a user controlling a client device in a network environment, where the user should not be permitted access. As another example, a deficiency can indicate aspects of a configuration of a network environment where a certain security level (e.g., certain level of encryption, etc.) is not implemented. In this example, the deficiency determination system can determine that the deficiency is due to a network environment does not meeting this security level. In yet another example, a deficiency can indicate aspects of network operation execution that are incorrect or not in compliance with one or more requirements such as requirements for processing payment transactions developed by industry associations or government agencies tasked with monitoring the implementation of payment processing.

In an example where the requirement update indicates a misconfiguration of the network environment, the deficiency determination system can determine deficiencies based on identifying one or more instances wherein aspects of a configuration of the network environment would lead to the network environment not functioning as intended. The deficiency determination system can, for instance, determine the first deficiencies based on analyzing one or more first network operations associated with the first network environment. In this example, the deficiency determination system can analyze traffic patterns, login attempts, device connections, access logs, anomaly alerts, etc. that can be derived from network operations executed by the network environment and determine that the deficiencies are implemented by the network environment. In another example, the deficiency determination system can analyze the configuration of a network environment to determine whether one or more deficiencies can be realized through the execution of network operations in accordance with that configuration. For example, the deficiency determination system can analyze network operations involving the calculation of interest that include amounts for transactions that are in dispute by a network environment. In this example, the deficiency determination system can determine that the deficiencies are present where network operations are identified as having been processed to include these miscalculated amounts.

In some embodiments, the deficiency determination system can determine the first deficiencies using a machine learning model (referred to generally as a model). For example, the deficiency determination system can provide the requirement data to a first model (e.g., an LLM) to cause the first model to generate at least one semantic output. The semantic output can be a summary of one or more possible issues (e.g., deficiencies) that can be present in a network environment as indicated by the requirement data as indicated by an event. To generate the semantic output, the deficiency determination system can provide a prompt with instructions on how to generate the semantic output along with the requirement data to the first model to cause the model to generate the semantic output in accordance with the prompt. As an example, the prompt can include instructions such as “Generate a summary identifying one or more deficiencies addressed by this text.” In response, the first model can generate a semantic output (e.g., a string or strings of text) that identifies deficiencies in configurations of network environments such as particular aspects of firewall configurations, coordination of execution of network operations by client devices, etc. In this way, the first model can be configured to analyze the requirement data for a given event in accordance with the prompt to filter portions of the requirement data and identify relevant aspects indicative of a deficiency.

In some embodiments, the deficiency determination system can use one or more models to generate context relevant to the requirement data, and the semantic output can be generated by the first model based on this context. For example, a second model can include a RAG model configured to receive an input and obtain relevant documentation (e.g., context) from a database. In this example, the deficiency determination system can provide at least a portion of the requirement data to the second model to cause the second model to generate a second output comprising context data associated with relevant documentation, etc. The context can be generated by providing the requirement data to the second model to cause the second model to query at least one retrieval database based on the requirement data, and obtain documents identifying information that is relevant to at least part of the requirement data, such as related incident reports, regulations, court or administrative documents, etc. The deficiency determination system can then update the input to the first model (the LLM) to include the requirement data, the context data, and/or the prompt to cause the first model to generate the semantic output as described above.

In some embodiments, the deficiency determination system can select a first model based on the context established by the output of the second model. As an example, the deficiency determination system can have access to a plurality of first models (e.g., LLMs) that have been trained (e.g., fine-tuned) to generate semantic output for specific domains (e.g., network environments implemented for specific industries, etc.). In this example, the deficiency determination system can select the first model from this plurality of models based on the context. In this way, the deficiency determination system can select a first model that is configured to generate outputs that satisfy the context. For example, the first model can be configured to generate output that satisfies (e.g., adequately describes) one or more requirements (e.g., legal network requirements, industry network requirements, etc.) included in the context. In examples where the plurality of models includes a plurality of LLMs, the deficiency determination system can provide the requirement data and/or a prompt to the LLM chosen as the first model to cause the LLM to generate the semantic output. The prompt can be a string of text that instructs the first model to generate semantic output in accordance with at least part of the context. As an example, the prompt can instruct the first model to “Generate a summary of one or more deficiencies addressed by the requirement data.” As a result, the first model can generate a summary of deficiencies representing possible network deficiencies related to the incident report and relevant requirements and/or indications of these deficiencies based on context that can include regulations, standards, and/or similar incident reports.

In some embodiments, the deficiency determination system can probe the first network environment by causing test network operations to be executed, and then analyze the test network operations from the probe to determine the first deficiencies. For example, in edge cases where deficiencies associated with a given event occur infrequently and may not be represented in a batch of network operations, the deficiency determination system can cause one or more test network operations to be executed that are configured to take advantage of the deficiency. The deficiency determination system can then analyze the test network operations as well as the operations executed by the client devices of the first network environment being probed to determine (e.g., confirm) whether the deficiencies are included in the first network environment. Similarly, the security system can analyze a second network environment as described herein by probing the second network environment to determine whether similar deficiencies are present in the second network environment.

At operation 406, the process 400 can include comparing one or more aspects of the one or more first deficiencies to one or more second network operations. For example, the deficiency determination system can transmit the first deficiencies to another component of the security system, such as a deficiency recognition system (e.g., that is the same as, or similar to, the deficiency recognition system 106 of FIG. 1). In this example, the deficiency recognition system can retrieve information associated with second network operations from a second network environment. The deficiency recognition system can then compare aspects of the first deficiencies to the execution of the second network operations. Based on this comparison, the deficiency recognition system can identify whether the second deficiencies are present in the second network environment. For example, the deficiency recognition system can identify one or more similarities (e.g., strings of text that are the same or similar) between first network operations associated with the first deficiencies and second network operations and, based on the similarities, determine that the one or more second deficiencies are present in the one or more second network operations.

In some embodiments, the security system can determine deficiencies of a plurality of network environments based on the first deficiencies associated with the first network environment. For example, the security system can select one or more network environments (e.g., including the second network environment) from a plurality of network environments based on determining that the second network environment has one or more similarities to the first network environment (e.g., is implemented for a similar industry, is configured to execute similar network operations, etc). In an example, the security system can select the second network environment based on determining that the second network environment has the same network type, is configured to process the same or similar network operations (e.g., payment transactions) as the first network environment, etc. As a result, the security system can select the second network environment such that the first network operations associated with the first network operation are similar to the second network operations of the second network environment and allow for comparisons to network environments that are likely to have similar deficiencies.

At operation 408, the process 400 can include determining one or more second deficiencies associated with the second network environment. For example, the deficiency determination system can provide data associated with (e.g., indicating) the first deficiencies to another component of the security system, such as the deficiency recognition system. In response to receiving the data associated with the first deficiencies, the deficiency recognition system can determine one or more second deficiencies associated with a second network environment. For example, the deficiency recognition system can identify one or more similarities between execution of operations by the first network environment and the execution of operations by the second network environment. Based on these similarities, and the first deficiencies, the deficiency recognition system can determine whether the second deficiencies are present in the second network environment.

In some embodiments, the deficiency determination system can determine deficiencies based on comparing the structures (e.g., configuration of client devices and/or how the client devices are configured to coordinate with each other within a given network environment when processing network operations) of the first and second network environments. For example, the deficiency recognition system can obtain a representation of the first and second network environment. The representation can include a knowledge graph or other similar representations that indicate the relationship of client devices to one another within the second network environment and the interconnections and dependencies between these client devices. In some examples, the knowledge graph can be based on the first network environment and matched with portions of the second network environment. For example, the knowledge graph can represent the structure of the first network environment, including one or more aspects of the configuration of the first network environment such as how the client devices are configured to communicate with each other, which client devices can communicate with other client devices, etc. In this example, the structure of the first network environment can be used to determine an indication of first deficiencies. For example, the deficiency recognition system can identify a configuration in the first network environment that is associated with a first deficiency based on information about the configuration of the first network environment included in the knowledge graph. In some examples, the deficiency recognition system can determine indications of deficiencies based on the representation and the semantic output that includes a description of one or more network deficiencies that could indicate a deficiency. In an embodiment, the deficiency recognition system can analyze the structure of the first network environment and/or the second network environment based on the semantic output. As a result, the deficiency recognition system can identify common patterns, configurations, or dependencies that indicate a deficiency in the first network environment, and subsequently identify the second deficiencies of the second network environment based on identifying these patterns based on the knowledge graph and the semantic output.

In some embodiments, the deficiency recognition system can determine deficiencies based on determining that a part of the knowledge graph satisfies the semantic output. Satisfying the semantic output can include displaying one or more deficiencies described by the semantic output. As an example, the semantic output can indicate account balances, minimum payments, etc. could be miscalculated when calculated based on a balance that includes disputed transactions. In this example, the deficiency recognition system can determine that there is a deficiency based on determining that there are circumstances under which the second network environment will calculate a minimum payment based on a balance that includes a disputed charge (either by identifying network operations that include such miscalculations, by probing the second network environment to cause the miscalculations, etc.).

At operation 410, the process 400 can include providing an indication of the one or more second deficiencies to cause one or more updates to be performed. For example, the deficiency recognition system can provide an indication of the second deficiencies to another component of the security system, such as the reconfiguration system. In an embodiment, the reconfiguration system can determine one or more modifications (e.g., reconfigurations of the network) that can resolve the deficiencies. In some examples, the reconfiguration system can cause one or more updates to be performed on the second network environment based on these reconfigurations. For example, the reconfiguration system can provide an indication of the second deficiencies to the second network environment to cause updates to be performed. As an example, the indication may be updated documentation (e.g., configuration files, protocols, software, an/or the like) with one or more changes that can resolve the second deficiencies.

In some embodiments, the reconfiguration system can determine hierarchies of deficiencies and cause the updates to be performed based on these hierarchies. For example, the reconfiguration system can determine a hierarchy between a subset of deficiencies included in the second deficiencies based on the knowledge graph. In this example, the reconfiguration system can determine one or more dependencies within the subset of deficiencies. For example, these deficiencies may describe causal relationships between the second deficiencies. In some examples, the dependencies of deficiencies may be associated with dependencies between client devices in the second network environment. In an example, the knowledge graph can include information about dependencies between client devices in the second network environment. These dependencies can be relevant to deficiencies, as a deficiency in an upstream client device configured to execute network operations can affect downstream client devices. Similarly, an error in a downstream client device can be caused by a deficiency in an upstream client device. In an embodiment, the reconfiguration system can provide indications of the second deficiencies to the second network environment based on the hierarchy of the subset of deficiencies. As a result, the second network environment can be updated based on this hierarchy.

In some embodiments, the reconfiguration system can transmit indications associated with the second deficiencies to relevant client devices in the second network environment. For example, each second deficiency can be associated with a client device that has, or is part of, an improper configuration that causes the second deficiency. In some examples, the reconfiguration system can transmit indications of second deficiencies including a first indication to a first client device and a second indication to a second client device. For example, the reconfiguration system can determine that the first client device and the second client device are both associated with second deficiencies based on the hierarchy discussed above. The first and second client device may, for instance, be dependent devices that are associated with the same second deficiency. Alternatively, these devices can be associated with separate second deficiencies. In described examples, the reconfiguration system can transmit the first indication to the first client device to cause it to be updated to resolve the associated second deficiency. Similarly, the reconfiguration can transmit the second indication to the second client device to cause it to be updated to resolve the associated second deficiency. In an example, the client devices may resolve deficiencies by implementing one or more changes in how the client devices are configured to execute operations within the second network environment. Additionally, or alternatively, a user associated with a client device can resolve the deficiency based on the indication. For example, the user can review the first indication (e.g., when displayed on a graphical user interface of the client device or another device capable of reconfiguring the client device) and change one or more settings associated with the client device and/or the second network environment based on the indication.

In some embodiments, the client devices in the second network environment can be associated with users (e.g., employees) that have roles in an organization associated with the second network environment. In these embodiments, the hierarchy can indicate a mapping of the roles of the users within the second network environment. The mapping may, for instance, represent relationships between levels of roles (e.g., technician, engineer, manager, etc.) established by the hierarchy. In an example, the hierarchy can indicate which components of the second network environment each user is associated with. The reconfiguration system may, in some examples, obtain the mapping of relationships between one or more levels established by the hierarchy and the plurality of client devices and determine a first client device and/or a second client device to provide the first and second indications of the deficiencies to based on this mapping.

Some embodiments of the present disclosure are described in connection with a threshold. As described herein, satisfying a threshold can refer to a value being greater than the threshold, more than the threshold, higher than the threshold, greater than or equal to the threshold, less than the threshold, fewer than the threshold, lower than the threshold, less than or equal to the threshold, equal to the threshold, etc.

The above-described embodiments of the present disclosure are presented for purposes of illustration and not of limitation, and the present disclosure is limited only by the claims which follow. Furthermore, it should be noted that the features and limitations described in any one embodiment can be applied to any embodiment herein, and flowcharts or examples relating to one embodiment can be combined with any other embodiment in a suitable manner, done in different orders, or done in parallel. In addition, the systems and methods described herein can be performed in real time. It should also be noted that the systems and/or methods described above can be applied to, or used in accordance with, other systems and/or methods.

The present techniques will be better understood with reference to the following enumerated embodiments:
1. Methods for determining security vulnerabilities that represent edge cases within a distributed computing system.
2. The method of any one of the preceding embodiments, further comprising: obtaining requirement data associated with one or more requirement updates in response to one or more events, the one or more events involving execution of one or more first network operations in a first network environment; determining one or more first deficiencies associated with the execution of the one or more first network operations based on the one or more requirement updates and the one or more first network operations; comparing one or more aspects of the one or more first deficiencies to execution of one or more second network operations in a second network environment; in response to comparing the one or more aspects of the one or more first deficiencies to the execution of one or more second network operations in a second network environment, determining one or more second deficiencies associated with the second network environment; and providing an indication of the one or more second deficiencies to cause one or more updates to be performed, the one or more updates indicating one or more reconfigurations for the second network environment.
3. The method of any one of the preceding embodiments, further comprising: monitoring at least one external database for one or more entries that are indicative of the one or more requirement updates; and in response to identifying at least one entry that is relevant to the execution of the one or more second network operations, obtaining the requirement data from the at least one external database.
4. The method of any one of the preceding embodiments, further comprising: monitoring at least one external database for one or more entries that are indicative of the one or more requirement updates; and in response to identifying at least one entry that is relevant to the execution of network operations in the second network environment, obtaining the requirement data from the at least one external database.
5. The method of any one of the preceding embodiments, further comprising: providing a portion of the requirement data and a prompt to a first model to cause the first model to generate an output comprising at least one semantic output; and determining the one or more first deficiencies based on the at least one semantic output.
6. The method of any one of the preceding embodiments, further comprising: obtaining a representation of the second network environment, where the representation comprises a knowledge graph generated based on the first network environment, wherein determining the one or more second deficiencies comprises: determining the one or more second deficiencies based on the knowledge graph and the at least one semantic output.
7. The method of any one of the preceding embodiments, further comprising: comparing the at least one semantic output to the knowledge graph; and in response to determining that the at least one semantic output satisfies at least a portion of the knowledge graph, determining the one or more second deficiencies.
8. The method of any one of the preceding embodiments, further comprising: determining a hierarchy of a subset of deficiencies included in the one or more second deficiencies based on the knowledge graph, wherein providing the indication of the one or more second deficiencies comprises: providing the indication of the one or more second deficiencies based on the hierarchy of the subset of deficiencies.
9. The method of any one of the preceding embodiments, wherein the indication of the one or more second deficiencies comprises a first indication and a second indication, further comprising: determining a first client device corresponding to the first indication and a second client device corresponding to the second indication based on the hierarchy of the one or more second deficiencies; and providing the first indication to the first client device and the second indication to the second client device.
10. The method of any one of the preceding embodiments, further comprising: obtaining a mapping between a plurality of client devices comprising the first client device and the second client device, the mapping representing relationships between one or more levels established by the hierarchy and the plurality of client devices.
11. The method of any one of the preceding embodiments, wherein the output comprises a first output, further comprising: providing a portion of the requirement data to a second model to cause the second model to generate a second output comprising context data, where the context data is associated with information that is relevant to the portion of the requirement data; and generating the prompt based on the context data to configure the first model to generate the at least one semantic output in accordance with the information that is relevant to the portion of the requirement data.
12. The method of any one of the preceding embodiments, further comprising: providing the portion of the requirement data to a retrieval-augmented generation model (RAG model); and causing the RAG model to query at least one retrieval database based on the portion of the requirement data to obtain the context data.
13. The method of any one of the preceding embodiments, further comprising: determining a context based on the one or more requirement updates; and determining the first model from among a plurality of first models based on the context, where the first model is configured to generate outputs that satisfy the context.
14. The method of any one of the preceding embodiments, further comprising: determining a large language model (LLM) from among a plurality of LLMs, the LLM configured to receive the requirement data and the prompt and generate the outputs that satisfy the context; and in response to determining the LLM, provide the requirement data and the prompt to the LLM to cause the LLM to generate the output.
15. The method of any one of the preceding embodiments, further comprising: in response to determining the context, determining a second model from among a plurality of second models based on the context, where a retrieval database associated with the second model is configured to process inputs associated with the context.
16. One or more non-transitory, computer-readable mediums storing instructions that, when executed by a data processing apparatus, cause the data processing apparatus to perform operations comprising those of any of embodiments 1-15.
17. A system comprising one or more processors; and memory storing instructions that, when executed by the processors, cause the processors to effectuate operations comprising those of any of embodiments 1-15.
18. A system comprising means for performing any of embodiments 1-15.

What is claimed is:

1. A system for determining security vulnerabilities that represent edge cases within a distributed computing system, the system comprising:
one or more processors; and
one or more non-transitory, computer-readable mediums having instructions recorded thereon that, when executed by the one or more processors, cause the one or more processors to perform operations comprising:
obtaining requirement data associated with one or more requirement updates in response to one or more events that compromise network environments, the one or more events involving execution of one or more first network operations in a first network environment;
determining one or more first deficiencies associated with the execution of the one or more first network operations based on the one or more requirement updates and the one or more first network operations, the one or more first deficiencies indicating one or more security vulnerabilities of the first network environment;
comparing one or more aspects of the one or more first deficiencies to execution of one or more second network operations in a second network environment;
in response to comparing the one or more aspects of the one or more first deficiencies to the execution of one or more second network operations in a second network environment, determining one or more second deficiencies indicating the one or more security vulnerabilities associated with the second network environment; and
providing an indication of the one or more second deficiencies to cause one or more updates to be performed, the one or more updates indicating one or more reconfigurations for the second network environment.

2. A method implemented using a computing system comprising one or more processors, the method comprising:
obtaining requirement data associated with one or more requirement updates in response to one or more events, the one or more events involving execution of one or more first network operations in a first network environment;
determining one or more first deficiencies associated with the execution of the one or more first network operations based on the one or more requirement updates and the one or more first network operations;
comparing one or more aspects of the one or more first deficiencies to execution of one or more second network operations in a second network environment;
in response to comparing the one or more aspects of the one or more first deficiencies to the execution of one or more second network operations in a second network environment, determining one or more second deficiencies associated with the second network environment; and
providing an indication of the one or more second deficiencies to cause one or more updates to be performed, the one or more updates indicating one or more reconfigurations for the second network environment.

3. The method of claim 2, wherein obtaining requirement data comprises:
monitoring at least one external database for one or more entries that are indicative of the one or more requirement updates; and
in response to identifying at least one entry that is relevant to the execution of the one or more second network operations, obtaining the requirement data from the at least one external database.

4. The method of claim 2, wherein obtaining requirement data comprises:
monitoring at least one external database for one or more entries that are indicative of the one or more requirement updates; and
in response to identifying at least one entry that is relevant to the execution of network operations in the second network environment, obtaining the requirement data from the at least one external database.

5. The method of claim 2, wherein determining one or more first deficiencies comprises:
providing a portion of the requirement data and a prompt to a first model to cause the first model to generate an output comprising at least one semantic output; and
determining the one or more first deficiencies based on the at least one semantic output.

6. The method of claim 5, further comprising:
obtaining a representation of the second network environment, where the representation comprises a knowledge graph generated based on the first network environment,
wherein determining the one or more second deficiencies comprises:
determining the one or more second deficiencies based on the knowledge graph and the at least one semantic output.

7. The method of claim 6, wherein determining the one or more second deficiencies comprises:
comparing the at least one semantic output to the knowledge graph; and
in response to determining that the at least one semantic output satisfies at least a portion of the knowledge graph, determining the one or more second deficiencies.

8. The method of claim 7, further comprising:
determining a hierarchy of a subset of deficiencies included in the one or more second deficiencies based on the knowledge graph,
wherein providing the indication of the one or more second deficiencies comprises:
providing the indication of the one or more second deficiencies based on the hierarchy of the subset of deficiencies.

9. The method of claim 8, wherein the indication of the one or more second deficiencies comprises a first indication and a second indication, the method further comprising:
determining a first client device corresponding to the first indication and a second client device corresponding to the second indication based on the hierarchy of the one or more second deficiencies; and
providing the first indication to the first client device and the second indication to the second client device.

10. The method of claim 9, wherein determining the first client device and the second client device comprises:
obtaining a mapping between a plurality of client devices comprising the first client device and the second client device, the mapping representing relationships between one or more levels established by the hierarchy and the plurality of client devices.

11. The method of claim 5, wherein the output comprises a first output, and wherein determining the one or more first deficiencies comprises:
providing a portion of the requirement data to a second model to cause the second model to generate a second output comprising context data, where the context data is associated with information that is relevant to the portion of the requirement data; and
generating the prompt based on the context data to configure the first model to generate the at least one semantic output in accordance with the information that is relevant to the portion of the requirement data.

12. The method of claim 11, wherein providing the portion of the requirement data to the second model comprises:
providing the portion of the requirement data to a retrieval-augmented generation model (RAG model); and
causing the RAG model to query at least one retrieval database based on the portion of the requirement data to obtain the context data.

13. The method of claim 5, further comprising:
determining a context based on the one or more requirement updates; and
determining the first model from among a plurality of first models based on the context, where the first model is configured to generate outputs that satisfy the context.

14. The method of claim 13, wherein determining the first model comprises:
determining a large language model (LLM) from among a plurality of LLMs, the LLM configured to receive the requirement data and the prompt and generate the outputs that satisfy the context; and
in response to determining the LLM, provide the requirement data and the prompt to the LLM to cause the LLM to generate the output.

15. The method of claim 13, further comprising:
in response to determining the context, determining a second model from among a plurality of second models based on the context, where a retrieval database associated with the second model is configured to process inputs associated with the context.

16. One or more non-transitory, computer-readable mediums comprising instructions that, when executed by one or more processors, cause the one or more processors to perform operations comprising:
obtaining requirement data associated with one or more requirement updates in response to one or more events, the one or more events involving execution of one or more first network operations in a first network environment;
determining one or more first deficiencies associated with the execution of the one or more first network operations based on the one or more requirement updates and the one or more first network operations;
comparing one or more aspects of the one or more first deficiencies to execution of one or more second network operations in a second network environment;
in response to comparing the one or more aspects of the one or more first deficiencies to the execution of one or more second network operations in a second network environment, determining one or more second deficiencies associated with the second network environment; and
providing an indication of the one or more second deficiencies to cause one or more updates to be performed, the one or more updates indicating one or more reconfigurations for the second network environment.

17. The one or more non-transitory, computer-readable mediums of claim 16, wherein the instructions that cause the one or more processors to obtain the requirement data cause the one or more processors to:
monitor at least one external database for one or more entries that are indicative of the one or more requirement updates; and
in response to identifying at least one entry that is relevant to the execution of the one or more second network operations, obtain the requirement data from the at least one external database.

18. The one or more non-transitory, computer-readable mediums of claim 16, wherein the instructions that cause the one or more processors to obtain the requirement data cause the one or more processors to:
monitor at least one external database for one or more entries that are indicative of the one or more requirement updates; and
in response to identifying at least one entry that is relevant to the execution of network operations in the second network environment, obtain the requirement data from the at least one external database.

19. The one or more non-transitory, computer-readable mediums of claim 16, wherein the instructions that cause the one or more processors to determine one or more first deficiencies cause the one or more processors to:
provide portion of the requirement data and a prompt to a first model to cause the first model to generate an output comprising at least one semantic output; and
determine the one or more first deficiencies based on the at least one semantic output.

20. The one or more non-transitory, computer-readable mediums of claim 19, wherein the instructions further cause the one or more processors to:
obtain a representation of the second network environment, where the representation comprises a knowledge graph generated based on the first network environment,
wherein the instructions that cause the one or more processors to determine the one or more second deficiencies cause the one or more processors to:
determine the one or more second deficiencies based on the knowledge graph and the at least one semantic output.
